(19) United States
(12) Patent Application Publication
(10) Pub. No.: US 2026/0329317 A1
(43) Pub. Date: Oct. 22, 2026

(54) Variable Volume Pressure Control System

(71) Applicant: The E3 Company, LLC, Kilgore, TX (US)

(72) Inventor: Clayton Elliott Dale, Townville, PA (US)

(21) Appl. No.: 19/695,941

(22) Filed: Jun. 2, 2026

Related U.S. Application Data
(63) Continuation of application No. PCT/US2024/058954, filed on Dec. 6, 2024.
(60) Provisional application No. 63/608,165, filed on Dec. 8, 2023.

(51) Int. Cl. G05D 16/20; B24C 9/00

(52) U.S. Cl. CPC G05D 16/208; B24C 9/00

(57) ABSTRACT

Systems and methods of use thereof that enable changes to the pressure in one or multiple fluid conduits, each of which may be monitored to provide system user function with signals and processor control. The system includes one or more variable volume mechanisms in fluid communication with the fluid conduit(s) and a valve assembly, both controlled via electronic signals from a control module. The combination may be actuated to increase or decrease pressure in the fluid conduit(s) either upstream or downstream of the system. An additional bypass valve assembly may be included to provide fluid exit from the fluid conduit(s), such as to purge the conduit(s) or bleed off excess fluids from the conduit(s).

### RELATED APPLICATIONS

This application is a continuation of International Patent Application No. PCT/US2024/058954, filed Dec. 6, 2024, which claims the benefit of priority to U.S. Provisional Application Ser. No. 63/608,165, filed on Dec. 8, 2023, the entire disclosures of which are relied upon and expressly incorporated herein by reference.

### TECHNICAL FIELD

The present invention generally relates to a pressure control system and methods to increase or reduce pressure in pressurized fluid process piping.

### BACKGROUND

Currently there are a number of solutions for pressure control within the industrial process piping sector. Some of these solutions attempt to utilize standard control valve designs having known restrictive geometries, but these solutions generally fail to meet the needs of an industry that processes fluid streams containing suspended abrasives. The distinct design characteristics of standard control valves, which include a physical geometric fluid flow path impedance, lead to direct communication of abrasives in the fluid stream with the sealing mechanism, resulting in poor seal reliability and high maintenance costs in both labor and expense. Furthermore, these standard control valves typically rely on a relatively slow operational characteristic to position the geometry in a manner useful to the process.

Other solutions attempt to place fixed orifice plates in the fluid stream, but these solutions are likewise unable to meet the needs of a process fluid containing abrasive media; while they improve upon the ease of maintenance, they fail to address the very elementary problem of long-term stability of an expected flowrate or pressure control due to erosive effects on the geometry of the fixed orifice plates. Moreover, these solutions are only able to produce a loss in fluid pressure condition and none are singularly able to produce both a net negative and net positive pressure condition change.

These valves or system of devices also fail to meet the demands of the oscillatory nature of a reciprocating pumped fluid system and cannot provide a pressure damping of the fluid stream. To control such oscillation, classical systems of valves must be combined for process outcome using complex sensor, actuation, assembly, and installation techniques. Still further, employed electronic valve controls do not allow a third-party user to integrate the control method and process signals from such units in coordination with their own methods, such as in an oil and gas wellbore stimulation pumping service with temporarily installed pressurized fluid process piping utilizing a third-party valve closing unit.

Accordingly, it would be desirable to have a system that can pressurize and depressurize fluids in a pressurized fluid process piping in a controlled manner.

### SUMMARY

The present invention advantageously addresses the aforementioned deficiencies by providing systems and methods that can, in a pressurized fluid process piping: depressurize in a controlled manner, pressurize in a controlled manner, and rapidly depressurize. More specifically, disclosed herein are systems and methods that provide pressure control by use of a variable volume mechanism coupled with intelligent valve controls, variable volume chamber(s), valve(s), actuator(s), and a control system designed to provide novel pressure control for process piping applications.

The systems and methods allow changes to the pressure in one or multiple fluid conduit(s), each of which may be monitored to provide system user function with signals and processor control. The disclosed systems, by virtue of having multiple rotary valves applied, may provide redundancy for process piping seal integrity needed for accurate process control and safety. The disclosed system may be modulated in a manner capable of producing thermal heat to help prevent process fluid viscosity increases, thus allowing efficient operational use. Furthermore, controls of the disclosed systems are designed such that the user can define all rotary valve or valve assembly setpoints independently and integrate valve control into their process logic and data management systems.

Accordingly, the present disclosure provides a system comprising a variable volume mechanism in fluid communication with a process piping and a valve assembly, referred to herein as an upstream valve assembly, both controlled via electronic signals from a control module. The combination may be actuated to increase or decrease pressure in the process piping either upstream or downstream of the system. In some implementations of the system, an additional valve assembly may be included to provide fluid exit from the process piping, such as to purge the process piping or bleed off excess fluids from the process piping. This additional valve assembly, referred to herein as a bypass valve assembly, may be configured to allow exit of fluid to exit to an energy reduction and containment system, such as a closed tank fluidly connected to an open tank.

The variable volume mechanism includes a flow path positionable on a process piping, also referred to herein as a primary conduit, such as via attachment of a first section of primary conduit to an inlet end of the flow path and attachment of a second section of primary conduit to an outlet end of the flow path. The variable volume mechanism includes a piston cylinder positioned perpendicular to the flow path and having a closed first end and an open second end that is in fluid communication with the flow path. A piston rod is positioned within the piston cylinder and configured for movement therein based on signals sent from a control module. In some implementations, a pneumatic or hydraulic chamber is formed between the first end of the piston cylinder and a top end of the piston rod, wherein the variable volume mechanism may include a piston actuator configured to move the piston rod by increasing or decreasing a volume of the pneumatic or hydraulic chamber. In other implementations, an electromagnetic positioning system may be included within the piston cylinder, wherein a position of the piston may be controlled by electrical input from an actuator.

The flow path of the variable volume mechanism includes a pressure port positioned proximate the inlet of the flow path. The upstream valve assembly is positioned inline on a secondary conduit, wherein the secondary conduit is attached via a first end to the pressure port and via a second end to the primary conduit, i.e., the first section of the primary conduit, upstream or distal from the inlet end of the variable valve mechanism. Upstream from the inlet end of the variable valve mechanism is relative to the direction of flow through the primary conduit and flow path from a fluid source to the inlet end of the variable volume mechanism and through the flow path to exit from the outlet end of the variable volume mechanism.

A check valve may be positioned on the primary conduit upstream of the inlet end of the variable valve mechanism, such as between the inlet end of the flow path of the variable volume mechanism and the connection point of the secondary conduit on the primary conduit. The check valve may stop the backflow of fluids from the flow path toward the upstream fluid source. In some implementations, the check valve may be part of the system, and in other implementations, the check valve may be absent or may be previously supplied on the primary conduit, i.e., not part of the system.

The control module is programmed to control the piston actuator and the upstream valve assembly based on signals from one or more pressure transmitters positioned on the primary conduit and secondary conduit, or from a user device, wherein the system is configured to increase or decrease a pressure in the primary conduit.

When a check valve is included, the pressure in the primary conduit may be increased or decreased either upstream or downstream of the check valve. For example, the control module may send electronic signals to the piston actuator to move the piston rod downward or upward to increase or decrease, respectively, a pressure in the primary conduit downstream of the check valves and variable volume mechanism. The control module may send electronic signals to the upstream valve assembly to open the fluid path therethrough so that fluid exits the pressure port and flows through the upstream valve assembly, and electronic signals to the piston actuator to move the piston rod downward or upward and to increase or decrease, respectively, the pressure upstream of the check valve.

According to certain implementations, the system may further comprise a bypass port positioned in the piston cylinder, wherein a substantially fully retracted position of the piston rod provides fluid communication from the flow path through the bypass port; and a bypass valve assembly positioned inline on a bypass conduit, wherein a first end of the bypass conduit is fluidly connected to the bypass port. In this configuration, the control module may be further configured to send electronic signals to the piston actuator to move the piston rod to the substantially fully retracted position and send electronic signals to the bypass valve assembly to open a fluid path therethrough so that fluid exits the pressure port and flows through the bypass valve assembly to decrease the pressure in the primary conduit, or to blead off or purge fluids from the primary conduit.

The system may further yet include an energy reduction and containment system fluidly connected to a second end of the bypass conduit. The energy reduction system may include a closed tank fluidly connected to an open tank. A temperature of a fluid flowing to the open tank may be monitor and controlled.

The various components of the system may be positioned on or within a frame configured to be transportable, such as to a site having process piping (i.e., primary conduit) carrying pressurized fluids.

According to various implementations, the upstream valve assembly and/or bypass valve assembly may comprise two or more valves positioned in series on the secondary or bypass conduit, respectively (i.e., fluid flows through one valve to the next valve). Alternatively, the upstream valve assembly and/or bypass valve assembly may comprise two or more valves positioned parallel on the secondary or bypass conduit, respectively (i.e., fluid flow splits to go through one or more additional fluid lines on which the valves are positioned inline). In either implementation, each valve may be individually actuatable. In preferred implementations, the valves are normally closed valves actuatable to the open position, such as normally closed rotary valves.

The present disclosure further provides methods of using the disclosed systems for pressure control and relief.

### BRIEF DESCRIPTION OF DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the present invention, unless stated to be otherwise, are not necessarily drawn to scale. The illustrative embodiments in the following drawings are not meant to be limiting; other embodiments may be utilized, and other changes may be made without departing from the spirit or scope of the subject matter presented herein.

FIG. 1 illustrates a diagram of a pressure control system according to aspects of the present disclosure.

FIG. 2 illustrates a block diagram showing electronic and mechanical communication of a valve system according to aspects of the present disclosure.

FIG. 3 illustrates a diagram of a pressure control system including multiple variable volume mechanisms according to aspects of the present disclosure.

### DETAILED DESCRIPTION

The present disclosure relates to systems for pressure control in a pressurized fluid process line and an associated control process. The present disclosure provides a variable volume mechanism (VVM) and control systems that afford effective pressure adjustment, e.g., increase or decrease pressure, pressure control, and/or pressure relief in fluid lines or conduits, such as those used in the hydraulic fracturing industry or in wellbore completion activities.

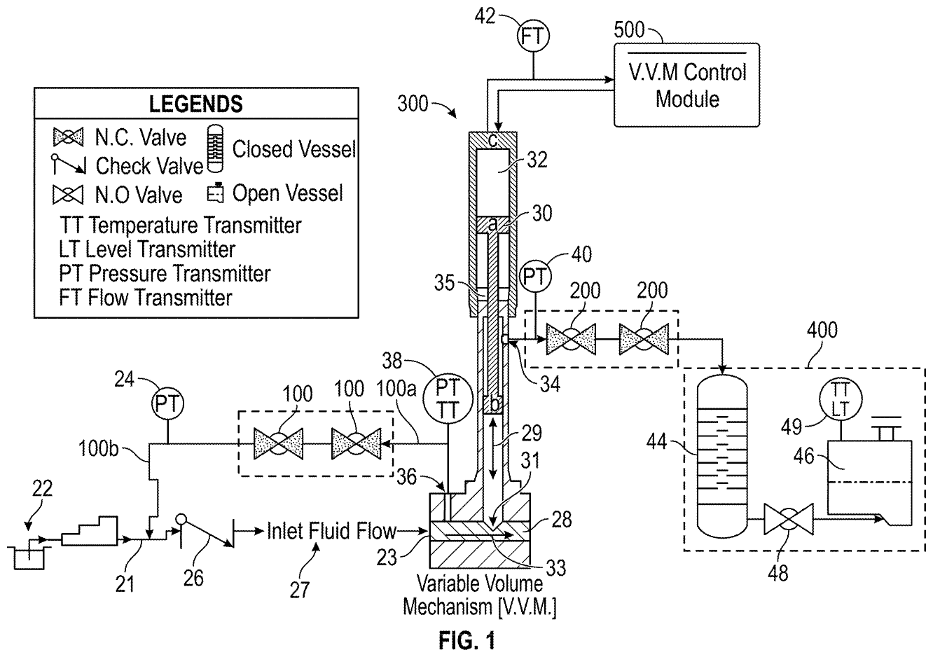

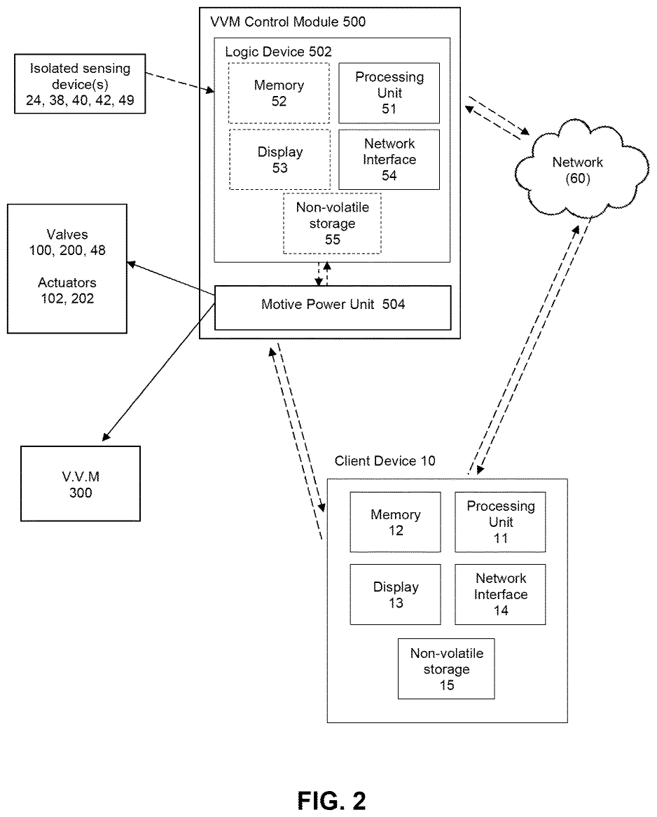

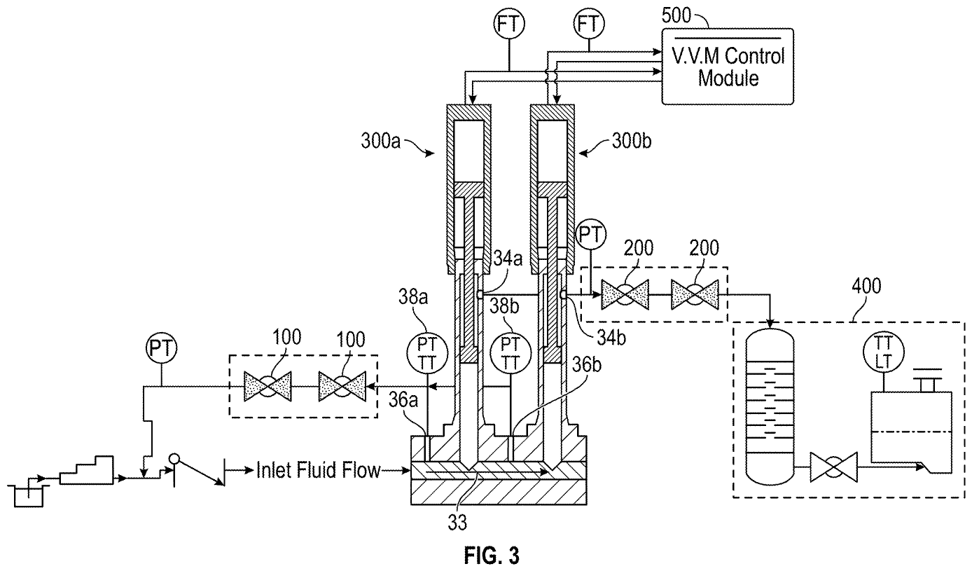

With reference to FIGS. 1 through 3, the system generally includes one or more variable volume mechanisms (VVM; 300 of FIGS. 1, 300a and 300b of FIG. 3), valves (100, 200), valve actuators (102, 202 of FIG. 2), condition sensing devices (pressure, temperature, flow, and level; 24, 38, 40, 42, 49), motive power unit(s) 504, and electronic control module(s) 500 which are applied to monitor, interpret, control, and provide user interface and/or information feedback. These components are structured such that the electro-mechanical controls will modulate the position of the variable volume mechanism(s) as well as automate the open and closed positions of the valves (100, 200) via function of the actuators (102, 202). The control architecture allows the system to monitor or interpret process piping conditions and manage the component positions based on user desired function or interpreted control algorithms and signals.

With specific reference to FIG. 1, the variable volume mechanism 300 comprises a piston cylinder having a longitudinal bore that is closed at a first end “c” and open at a second end 31 opposite the first end. The open second end 31 is in direct fluid communication with a lateral bore (flow channel 33) configured for a flow direction from an inlet end 23 (inlet fluid flow 27) to an outlet end (outlet flow 28) as shown by the arrow in the flow channel 33. As described herein, all regions before the inlet end 23 of the flow channel 33 are described as upstream and all regions after the outlet end of the flow channel are described as downstream, i.e., upstream is relative to the direction of fluid flow shown by the arrow in flow channel 33. A piston rod 30 is positioned within the longitudinal bore of the piston cylinder and is moveable along a longitudinal axis of the longitudinal bore, as shown by arrow 29.

A region within the longitudinal bore of the piston cylinder that is defined by a top end ‘a’ (i.e., the piston) of the piston rod 30 and the closed first end ‘c’ of the piston cylinder forms a hydraulic or pneumatic chamber 32. Hydraulic fluid or gas may be pumped into or out of the chamber 32 to move the piston rod 30 down or up (arrow 29), respectively, within the piston cylinder of the VVM 300. In some implementations, the piston rod 30 may be moved within the piston cylinder by an electro-magnetic system, such as via electro-magnets or a coil positioned along the longitudinal bore proximate to the closed first end ‘c’ of the piston cylinder and extending toward the open second end 31. Electrical impulses sent to the coil or magnetic fields generated may cause the piston rod to move within the longitudinal bore.

The region within the longitudinal bore defined by a second end ‘b’ of the piston rod 30 and the open second end 31 of the longitudinal bore forms a variable volume chamber.

A stop 35 within the longitudinal bore of the piston cylinder may limit a longitudinal position of the piston ‘a’ of the piston rod 30 within the longitudinal bore. Exemplary stops include at least a reduced diameter region of the longitudinal bore, a lip or other continuous or discontinuous circumferential protrusion(s) on a wall of the longitudinal bore. Such protrusions may be contiguous with the wall of the longitudinal bore or may be a secondary mechanism installed to create the stop.

The VVM 300 may be positioned inline on a conduit, such as process piping carrying pressurized fluid with or without suspended abrasives. As used herein, the terms process piping and primary conduit may be used interchangeably and should be understood to refer to a conduit configured to carry process fluids. A first section of the primary conduit may be attached to the inlet end 23 of the flow channel to carry an inlet fluid flow 27 therethrough. Such fluid may originate from any fluid source 22 and may be pumped at a user desired flow rate and pressure through the primary conduit. A second section of the primary conduit carrying an outlet fluid flow 28 may be attached to an outlet end of the flow channel 33. The first and section sections of the primary conduit may be any conduit requiring meaningful use of the process fluid, e.g., process piping carrying pressurized fluids to a frac site or well head, for use in mineral extraction or mining, and the like.

A pressure port 36 is positioned in an upstream region of the flow channel 33, i.e., upstream of the second end 31 of the longitudinal bore with respect to the direction of fluid flow (see arrow), proximate to the inlet end 23 of the flow channel 33. Process fluid flowing through the pressure port 36 will pass through one or more upstream valves 100 and flow lines (100a and 100b; also referred to herein as a secondary conduit) to a region of the first section of the primary conduit upstream of the inlet end 23 of the VVM 300. As shown in FIG. 1, when the upstream valve assembly 100 is positioned inline on the secondary conduit (100a, 100b), a first end of the secondary conduit may be attached to the pressure port 36 and a second end of the secondary conduit may be attached to the primary conduit at a connection point 21 that is upstream of the inlet end 23 of the VVM 300.

The pressure and/or temperature of the fluid flow through the secondary conduit and upstream valve assembly may be monitored by one or more pressure and/or temperature transmitters (24, 38). The one or more upstream valves 100 may be normally closed valves actuated to open by an electric motor, electromagnetic system, or by a pneumatic or hydraulic actuator (102 in FIG. 2). Exemplary upstream valves include at least rotary valves.

In certain implementations of the system, only the VVM 300, upstream valve assembly 100, and certain sensors (e.g., pressure and/or temperature transmitters; 24, 38, 42) are provided. Conduit attachable to the various inlets, outlets, or ports would be provided by a user. As such, the user may fluidly connect an end of their process piping to the inlet end 23 of the VVM 300, attach the upstream valve assembly 100 inline on a secondary conduit, and fluidly connect a first end of the secondary conduit to the pressure port 36 and a second end of the secondary conduit to their process piping (e.g., connection point 21) upstream from the inlet end 23 of the VVM 300.

In other implementations of the system, sections of conduit may be supplied with the VVM 300, upstream valve assembly 100, and sensors (e.g., pressure and/or temperature transmitters; 24, 38, 42). For example, the upstream valve assembly 100 may be supplied already positioned inline on a secondary conduit, a first end of which may be connected to the pressure port. In this case, the user would fluidly connect an end of their process piping to the inlet end 23 of the VVM 300 and attach a second end of the secondary conduit to their process piping (e.g., connection point 21) upstream from the inlet end 23 of the VVM 300.

Alternatively, a section of primary conduit may be provided (e.g., region between connection point 21 and inlet end 23), such as attached via a first end to the inlet end 23 of the VVM 300. The upstream valve assembly 100 may be provided positioned inline on a secondary conduit, wherein a first end of the secondary conduit may be connected to the pressure port 36 and a second end may be connected to the section of primary conduit proximate a second end thereof. In this case, the user would fluidly connect an end of their process piping to the second end of the section of primary conduit provided with the system.

A check valve 26 may be positioned on the first section of the primary conduit upstream of the inlet end 23 of the VVM 300 to restrict back flow from the VVM 300 toward the fluid source 22. In some implementations, the check valve 26 is supplied on the primary conduit prior to attachment and use of the disclosed system, i.e., a system comprising at least the VVM 300 and upstream valve assembly 100. In other implementations, the check valve 26 may be included as part of the system. In this latter case, the check valve 26 may be installed on the first section of the primary conduit as a separate component. That is, a user would provide the process piping connectable to the inlet end 23 of the VVM 300 and would need to install the check valve 26 on their process piping upstream from the inlet end 23 of the VVM 300.

Alternatively, the system may include the check valve 26 integrated on conduit provided as part of the system, i.e., integrated with the VVM 300 and upstream valve assembly 100. For example, the system may include a section of primary conduit having a first end attached to the inlet end 23 of the VVM 300 (the primary conduit section shown as the region labelled 27 in FIG. 1). The section of primary conduit may include the check valve 26 positioned proximate a second end of the primary conduit section. The system may further include the upstream valve assembly 100 positioned inline on the secondary conduit, i.e., first and second sections, 100a and 100b, respectively, as shown in FIG. 1. A first end of the secondary conduit (open end of section 100a) may be fluidly connected to the pressure port and a second end of the secondary conduit (open end of section 100b) may be fluidly connected at or adjacent to the second end of the primary conduit section upstream of the check valve 26. In this implementation, a user would fluidly connect an end of their process piping to the second end of the primary conduit section.

The fluid pressure upstream of the VVM 300 may be increased by decreasing the internal wetted volume of the variable volume chamber of the VVM 300 when the upstream valves 100 are actuated to an open position. That is, increasing the volume of the pneumatic or hydraulic chamber 32, such as via increased pneumatic or hydraulic fluid volume therein, pushes the piston rod 30 down to reduce the volume of the variable volume chamber (i.e., region within the longitudinal bore defined by a second end ‘b’ of the piston rod 30 and the open second end 31 of the longitudinal bore). Alternatively, an electromagnetic system as described hereinabove may push the piston rod 30 down to reduce the volume of the variable volume chamber. When the upstream valves 100 are actuated to an open position, a portion of the fluid flow exits the pressure port 36 and flows through the upstream valve(s) 100 and flow lines 100a and 100b to a position in the primary conduit upstream of the check valve 26.

Likewise, an increased internal wetted volume of the variable volume chamber of the VVM 300 may act to decrease fluid pressure upstream of the VVM 300 when the upstream valves 100 are actuated to an open position. That is, the volume of chamber 32 may be reduced and the piston rod 30 may be forced upward by the force of the fluid flow 27 in the flow channel 33, or by the vacuum effect of the piston's movement upward, to increase the volume of the variable volume chamber. If the upstream valves 100 are actuated to an open position, a portion of the fluid in the conduit upstream of the check valve 26 may be pulled into the VVM 300 through the upstream valves 100, flow lines 100a and 100b, and the pressure port 36. This movement of additional fluid through the VVM 300 may decrease the fluid pressure in the conduit upstream of the VVM 300 or equalize the fluid pressure across the check valve 26.

Alternatively, when the upstream valves 100 remain closed, i.e., are not actuated to the open position, the VVM 300 may increase or decrease the fluid pressure downstream of the VVM 300. That is, in the event of a process upset requiring rapid fluid pressure increase, the upstream valves 100 may remain closed and the fluid pressure downstream of the VVM 300 may be increased by decreasing the internal wetted volume of the VVM 300, i.e., the piston rod 30 moves downward. Alternatively, in the event of a process upset requiring rapid fluid pressure decrease, the upstream valves 100 may remain closed and the fluid pressure downstream of the VVM 300 may be decreased by increasing the internal wetted volume of the VVM 300, i.e., the piston rod 30 moves upward.

The piston rod 30 may be actuated to move at any rate and to stop at positions useful to achieve a desired or set pressure increase or decrease upstream or downstream of the VVM 300. Such rates and the stop position may be controlled by a control module based on sensor input, user input from a remote device, or a combination thereof (see discussion below).

The VVM 300 may also include a bypass port 34 that provides fluid exit therefrom, such as to purge the process piping or allow excess fluids from the process piping. For example, the longitudinal bore may include a bypass port 34 positioned below the stop 35. When the piston rod 30 is moved upward to a position that exposes the bypass port 34, such as when a pressure decrease in the process piping is desired, one or more normally closed bypass valves 200 may be actuated to an open position. Fluid may exit the VVM 300 via the bypass port 34 and the open bypass valve(s) 200 to any arrangement of energy reduction devices and/or containment 400. Exemplary energy reduction may include a closed vessel with baffle plates 44 that is subsequently attached to a vented tank 46 via a normally open valve 48. A level and optionally temperature of fluids within the vented tank 46 may be monitored by a level and temperature transmitter 49. A pressure of the fluid exiting the bypass port 34 may be monitored by a pressure transmitter 40.

Fluid discharging from the bypass valve(s) 200 may be additionally or alternatively redirected to other areas of the process for meaningful use. Moreover, the bypass port 34 may also be used as a secondary fluid injection port depending on the meaningful use required by the process. Further yet, the bypass port 34 connection may be comprised of multiple ports allowing additional meaningful uses.

As described hereinabove, the VVM 300 is included as part of a system that also comprises the upstream valves 100, bypass valves 200, valve actuators (102, 202), condition sensing devices (pressure, temperature, flow, and level; 24, 38, 40, 42), motive power unit(s) 504, and electronic control module(s) 500. The system may also include energy reduction devices and/or containment 400, having associated valves 48 and sensors 49.

In an exemplary arrangement of the system, the VVM 300 is fluidly connected to the rotary valve(s) (100, 200), which may be mechanically coupled to rotary actuator(s) (102, 202). The rotary actuator(s) (102, 202) are coupled to a motive power circuit 504. The motive power circuit 504 is electrically coupled to the electronic logic device 502 as part of the VVM control module 500. The electronic logic device 502 may be electrically coupled to a remote user interface, such as the client device 10 (see FIG. 2). The isolated sensing device(s) may be coupled electrically to the electronic logic device 502.

According to certain aspects, the system may include more than one VVM 300. For example, and with reference to FIG. 3, the system may include two or more VVMs (300a, 300b) positioned in series on a fluid conduit, e.g., process piping. While the two VVMs (300a, 300b) are depicted in FIG. 3 as adjacent to each other and sharing the same flow channel 33, i.e., such as a manifold, the VVMs may be positioned along the primary conduit at any location and/or may not share the same flow channel 33 but may include a portion of conduit positioned therebetween.

Each of VVM 300a and VVM 300b includes a pressure port (36a and 36b, respectively), but the flow from each pressure port is generally directed through the same valve(s) 100. Similarly, each VVM (300a, 300b) includes a bypass port (34a and 34b, respectively), and fluid may exit the VVMs via the bypass port through an open bypass valve(s) 200 to any arrangement of energy reduction devices and/or containment 400. Control of the piston rods for each VVM (300a, 300b) may be via the same VVM control module 500.

The valves may include any type of actuator (102, 202) configured to operate the valve (100, 200) from the closed position to an open position, and then back to the closed position during each of a plurality of operation cycles, or from the open position to a closed position (e.g., valve 48) and back. In some cases, each valve actuator (102, 202) may be a solenoid actuator, a hydraulic actuator, an electromagnetic actuator, an electric motor, pneumatic actuator, and/or other similar or different types of actuators, as desired. According to certain embodiments, each valve actuator (102, 202) may be a pneumatic or hydraulic actuator driven by an actuator fluid. Such an embodiment may provide improved safety on extreme worksites, such as those of a standard hydraulic fracturing or wellbore completion operation (e.g., exposure to extremes temperatures and weather).

As shown in FIGS. 1 and 3, the system may include transmitters for sensors positioned at various locations, e.g., before and/or after valves or valve assemblies, on the process piping, on hydraulic or pneumatic actuators such as on fluid lines from the piston actuator to the hydraulic or pneumatic chamber, and/or on fluid containment tanks. Moreover, each sensor may include more than one transmitter. In certain exemplary implementations of the system, three transmitters may be included for critical sensors, such as pressure sensors. Such redundancy provides a near fail-safe system; should one transmitter work improperly or fail, the readings from the failed transmitter would differ from those of the other two transmitters. The system would be configured to discard the “odd” third pressure reading from the failed transmitter and register the correct readings from the other two transmitters.

Exemplary pressure sensors may include a diaphragm configured to sense an external pressure and deform to translate that external pressure to an internal pressure on a pressure fluid within a pressure chamber (i.e., pressure against the diaphragm pressurizes the pressure fluid within the pressure chamber). The diaphragm may be any deformable material capable of responding to pressure within a user selected range. For example, as detailed above, the diaphragm may be a metal or polymer capable of registering pressure, i.e., reversible deformation, in the range of 10,0000 psi to 30,000 psi. This pressurization of the pressure fluid is then registered by the at least one pressure transmitter and converted to an electrical signal. The electrical signal may then be communicated to the VVM control module 500 where the signal may be calculated and utilized to control actuation of the various valves of the system. Such communication may be direct, such as via cables, or wireless.

The presently disclosed system may include other redundant aspects to protect overall operation, such as filters for actuator fluids positioned in fluid lines leading to a pressurization chamber, i.e., pneumatic or hydraulic chamber 32 of the VVM 300, and/or in fluid lines leading to a pressurized fluid storage tank (e.g., hydraulic fluid).

All of the actions of the various valves, i.e., upstream valves 100, bypass valves 200, and optionally, valve(s) 48 in a containment arrangement, may be controlled by a VVM control module 500 based on control logic communicated to a motive power unit 504. With reference to FIG. 2, each of these components may be controlled by control logic executed on a processing unit 51 of the logic device 502. Input from the various sensors may be relayed to the logic device 502 via direct electrical connection, such as from the various sensors and actuators to the logic device 502. The logic device 502 may be programmed to respond to specific sensor input to control the positions of the various valves and the piston rod 30.

According to certain aspects, the VVM control module 500 may further include memory 52 and optionally non-volatile storage 55 and a display 53. The display panel 53 may provide a means for display of system information or status. The display panel 53 could also be configured for receive user input and direct the user input to the VVM control module 500.

According to certain aspects, the VVM control module 500 may further include a network interface 54 that provides connection to external components via a network 60, such as to the client device 10. This connection may be used to provide instructions to the VVM control module 500 from the client device 10 or relay information from the VVM control module 500 to the client device 10, such as via Bluetooth, intranet, or internet communication. The network connection may also provide connection to network enabled sensors, such as any of the sensors discussed hereinabove.

The VVM control module 500 may monitor, interpret, control, and provide user interface or information feedback regarding performance of the system and values returned from the various sensors (pressure, temperature, flow, and level transmitters). Moreover, the system may be configured in various control methodologies. For example, a singularly controlled valve, e.g., single upstream valve 100 or bypass valve 200, may be controlled through interpretation of a single pressure sensing point or multiple pressure sensing points. Alternatively, two separate valves may be positioned in series or parallel and may be controlled independently or in unison through interpretation of the one or more pressure sensing points. Still further, single or multiple valves may be controlled through interpretation of an input signal provided by a user, such as through a user-controlled override at the VVM control module 500 or via a wireless signal sent from a client device 10. Where the operational control signal is supplied by others, the inherent on-board logic may act in a back-up manner to provide redundancy.

High-and low-pressure limits may be set on the VVM control module 500. These may be set by the user or may be preset based on a standard type of service on a standard type of high-pressure conduit. Moreover, a user may start with present values and make changes thereto based on adaptations to the high-pressure conduits, current environmental conditions, etc.

The high-and low-pressure limits may be those known in the industry of use. For example, in the hydraulic fracturing industry, the high-pressure conduits can be rated to withstand fluid pressures of up to 10,000 psi, or up to 20,000 psi, or even up to as much as 30,000 psi. The high-pressure limits may therefore be set based on the rating of the high-pressure conduit, and may be set at the rated pressure limit, or below the rated pressure limit. Such settings are known to those of skill in the art. The low-pressure limits may be adjusted to be at least 10% below the high-pressure limit, such as at least 1,000 psi below the high-pressure limit, or at least 2,000 psi below the high-pressure limit, or at least 5,000 psi below the high-pressure limit, or even 10,000 psi below the high-pressure limit.

The VVM control module 500 will receive signals from the pressure transmitters indicating a fluid pressure in the conduit and communicate with the valve actuation system to change a position of the upstream or bypass valve(s) as described hereinabove. According to certain aspects of the present invention, control logic is implemented by the VVM control module 500 that causes the upstream or downstream valve(s) to remain open until a downward or upward trend is registered in the pressure reading(s). For example, in response to a high-pressure event, at least the next pressure reading after a recovery pressure set point has been reached must also be below the recovery pressure set point, such as by an amount at least 10% below, or 30% below, or even 50% below the previous pressure reading, after which the valve position may be changed. Alternatively, in response to a low-pressure event, at least the next pressure reading after a recovery pressure set point has been reached must also be above the recovery pressure set point, such as by an amount at least 10% below, or 30% below, or even 50% below the previous pressure reading, after which the valve position may be changed.

It is to be appreciated that aspects of the VVM control module 500/or client device 10 can be implemented by various types of operating environments, computer networks, platforms, frameworks, computer architectures, and/or computing systems. Further, while specific discussion regarding control logic for actuating the positions of various valves and the piston rod are discussed, VVM control module 500 may include calibration algorithms for sensors that may be included as part of the system or may allow user override of system registered values.

Implementations of the VVM control module 500 and/or client device 10 are described within the context of a device configured to perform various steps, methods, and/or functionality in accordance with aspects of the described subject matter. It is to be appreciated that a control system such as a computing device or computer system can be implemented by one or more computing devices. As such, implementations of the VVM control module 500 and/or client device 10 can be described in the context of a “device configured to”, wherein the term configured may be taken to mean that the device can implement computer-executable instructions that are executed to perform various steps, methods, and/or functionality in accordance with aspects of the described subject matter.

In general, a computer system or computing device can include one or more processors and storage devices (e.g., memory and disk drives) as well as various input devices, output devices, communication interfaces, and/or other types of devices. A computer system or computing device can also include a combination of hardware and software. It should be appreciated that various types of computer-readable storage media can be part of a computer system or computing device. As used herein, the terms “computer-readable storage media” and “computer-readable storage medium” do not mean and unequivocally exclude a propagated signal, a modulated data signal, a carrier wave, or any other type of transitory computer-readable medium. In various implementations, the VVM control module 500 and/or client device 10 may include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

The VVM control module 500 and/or client device 10 can implement and utilize one or more program modules. Generally, program modules include routines, programs, objects, components, data structures, etc., that perform particular tasks or implement particular abstract data types.

The client device 10 can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, which are linked through one or more communications networks. In a distributed computing environment, program modules can be in both local and remote computer storage media including media storage devices. Still further, the aforementioned instructions can be implemented, in part or in whole, as hardware logic circuits, which can include a processor.

The client device 10 can be implemented by one or more computing devices such as computers, PCs, server computers configured to provide various types of services and/or data stores in accordance with aspects of the described subject matter. Exemplary server computers can include, without limitation: web servers, front end servers, application servers, database servers, domain controllers, domain name servers, directory servers, and/or other suitable computers.

Components of the client device 10 can be implemented by software, hardware, firmware, or a combination thereof. For example, the client device 10 can include components implemented by computer-executable instructions that are stored on one or more computer-readable storage media and that are executed to perform various steps, methods, and/or functionality in accordance with aspects of the described subject matter.

The client device 10 can include a controller, i.e., a processor 11 and memory 12, and additional hardware storage 15, input devices 13, and output devices. The client device 10 can contain one or more communication interfaces 14 that allow communication with other computing devices and/or other computer systems. The client device 10 can include and/or run one or more computer programs implemented, for example, by software, firmware, hardware, logic, and/or circuitry of the client device 10. Computer programs can include an operating system implemented, for example, by one or more exemplary operating systems described above and/or other type of operating system suitable for running on computing device. Computer programs can include one or more applications.

The system may be powered via a direct AC or DC connection, such as via one or more rechargeable batteries. The batteries may be used to power at least the VVM control module 500 and the valve actuation system(s) (102, 202), i.e., the motive power unit 504. These batteries may be rechargeable battery cells. Further, the batteries may include a charge sensor configured to sense a charge state of the at least one battery cell, and a circuit electrically connected to the charge sensor for receiving a signal indicative of the charge state of the at least one battery cell. Additional sensors may be included which register a temperature, voltage, current, etc. of the at least one battery, and such information (data) may also be relayed via a circuit to the VVM control module 500 and may be shown visually on the display 53 and/or a charging indicator lamp. The battery may also indicate the charge status by an audible signal that may change (e.g., start at a certain charge state, grow louder and/or increase frequency of signal, etc.) as the battery is progressively discharged.

When more than one battery cell is included, each individual battery may include a charge sensor (and optionally additional sensors), which may communication via individual circuits, or may communicate directly, to a battery management system. Such a system manages a rechargeable battery (cell or group of cells), such as by protecting the battery from operating outside its safe operating area, temperature, voltage, etc. and by monitoring its state, calculating secondary data, reporting that data, controlling its environment, authenticating it and/or balancing the usage of individual cells in a groups of cells. The at least one battery may further include a connection means for an external power source which may provide for recharging of the at least one battery cell. For example, the external power source may be provided by AC power from a combustion engine generator equipped with a GFCI outlet, and the connection means may include a standard power cord.

The various components of the system may be included in a frame which may be transportable, such as a road transportable frame. According to certain aspects of the invention, the system includes the VVM 300, the VVM control module 500, upstream valve(s) 100, downstream valve(s) 200, and various sensors (e.g., 24, 38, 40, and 42). According to certain aspects, the system may further include energy reduction devices and/or containment 400, such as closed and/or open fluid tanks (44, 46) and associated valves 48 and sensors 49.

The frame may include a mount for the VVM control module 500 and may optionally include vibration isolation on the mount to lessen the impact of vibrations from the valve assembly on the VVM control module 500. According to certain aspects, VVM control module 500 may be a detachable component.

The above summary and drawings are not intended to describe or show each illustrated embodiment or every possible implementation of the presently disclosed systems and methods. Rather, various aspects of the systems and methods disclosed herein are described and illustrated with reference to one or more exemplary implementations. Moreover, while specific embodiments of the invention have been described in the detailed description, it should be appreciated by those skilled in the art that various modifications and alternations and applications could be developed considering the overall teachings of the disclosure. Accordingly, the arrangements, systems, apparatuses, and methods disclosed are meant to be illustrative only and not limiting as to the scope of the invention. For example, while the systems and methods of the present invention have been described as useful for monitoring and adjusting pressure conditions of high-pressure conduits, such as those used in the hydraulic fracturing industry and in wellbore completion activities, they may easily find use in other types of conduits and in other industries as would be understood by someone of ordinary skill in the art, such as in mining activities.

As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described component, event, or circumstance may or may not occur, and that the description includes instances where the event occurs and instances where it does not. In addition, the word “comprising” as used herein means “including, but not limited to.”

Various aspects of the systems disclosed herein may be illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled”, “directly attached,” and/or “directly joined” to another component, there are no intervening elements shown in said examples.

Relative terms such as “lower” or “bottom” and “upper” or “top” may be used herein to describe one element's relationship to another element illustrated in the drawings. It will be understood that relative terms are intended to encompass different orientations of aspects of the systems in addition to the orientation depicted in the drawings. By way of example, if aspects of the variable valve mechanism shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

It must also be noted that as used herein and in the appended claims, the singular forms “a,” “an,” and “the” include the plural reference unless the context clearly dictates otherwise. For example, although reference is made herein to “a” valve, “an” actuator, or “the” control module, one or more of any of these components and/or any other components described herein can be used. “Substantially,” as used herein, is understood to mean to a great or significant extent, such as at least 80%, or 90%, or 95%, 96%, 97%, 98%, or even 99%. For example, when an object is described as having a property substantially the same as a comparative such as a diameter or shape, etc., the property will be within at least 80% of the value of the comparative.

Unless defined otherwise, all technical and scientific terms used herein have the same meanings as commonly understood by one of ordinary skill in the art.

What is claimed is:

1. A system for pressure control in a primary conduit, the system comprising:
a variable volume mechanism configured to be connected to the primary conduit, the variable volume mechanism comprising:
a flow path having an inlet end and an outlet end,
a piston cylinder positioned perpendicular to the flow path, the piston cylinder having a first end that is closed and a second end that is in fluid communication with the flow path,
a piston rod movably positioned within the piston cylinder, and
a pressure port positioned proximate the inlet end of the flow path;
an upstream valve assembly connected to a second end of a secondary conduit, wherein a second end of the secondary conduit is fluidly connected to the primary conduit at a connection position that is upstream of the inlet end of the flow path;
one or more pressure transmitters connected to the secondary conduit; and
a control module programmed to control the piston rod and the upstream valve assembly based on signals from the one or more pressure transmitters or from a user device,
wherein the system is configured to increase or decrease a pressure within the primary conduit.

2. The system of claim 1, further comprising a piston actuator configured to move the piston rod by increasing or decreasing a volume of a chamber in the piston cylinder.

3. The system of claim 1, further comprising an electromagnetic system configured to move the piston rod within the longitudinal bore, wherein the electromagnetic system is positioned within a longitudinal bore of the variable volume mechanism.

4. The system of claim 1, wherein the upstream valve assembly comprises a rotary valve.

5. The system of claim 1, wherein the upstream valve assembly comprises a valve that is normally closed and configured to open.

6. The system of claim 1, wherein the one or more pressure transmitters comprises a pressure transmitter positioned on the secondary conduit at either or both ends of the upstream valve assembly.

7. The system of claim 1, wherein the primary conduit comprises a check valve positioned upstream of the inlet end of the flow path of the variable volume mechanism and downstream of the connection position of the secondary conduit to the primary conduit, and wherein the control module is configured to:
send electronic signals to a piston actuator to move the piston rod downward to increase a pressure in the primary conduit downstream of the variable volume mechanism, or
send electronic signals to the piston actuator to move the piston rod down and electronic signals to the valve assembly to open the flow path through the upstream valve assembly so that fluid exits the pressure port and flows through the upstream valve assembly to increase the pressure in the primary conduit upstream of the check valve, or
send electronic signals to a piston actuator to move the piston rod upward to decrease a pressure in the primary conduit downstream of the variable volume mechanism, or
send electronic signals to the piston actuator to move the piston rod upward and send electronic signals to the upstream valve assembly to open the flow path through the upstream valve assembly so that fluid is pulled into the flow path through the upstream valve assembly and the pressure port to decrease the pressure in the primary conduit upstream of the check valve.

8. The system of claim 1, wherein the control module controls the piston actuator and the upstream valve assembly to increase or decrease the pressure in the primary conduit when signals from the one or more pressure transmitters indicate a fluid pressure in the primary conduits is below or above, respectively, a user defined pressure or flow rate limit.

9. The system of claim 1, further comprising:
a bypass port positioned in the piston cylinder, wherein a substantially fully retracted position of the piston rod provides fluid communication from the flow path through the bypass port; and
a bypass valve assembly positioned inline on a bypass conduit, wherein a first end of the bypass conduit is fluidly connected to the bypass port and a second end of the bypass conduit is fluidly connectable to an energy reduction system.

10. The system of claim 1, wherein the system is configured to send electronic signals to a piston actuator to move the piston rod to the substantially fully retracted position and send electronic signals to the bypass valve assembly to open a fluid path through the bypass valve assembly so that fluid exits the bypass port and flows through the bypass valve assembly.

11. The system of claim 1, further comprising an energy reduction system, wherein the energy reduction system includes a closed tank fluidly connected to an open tank, and wherein a temperature of a fluid flowing to the open tank is monitor and controlled.

12. The system of claim 1, further comprising a frame configured to contain the upstream valve assembly, the variable volume mechanism, and the control module.

13. A method for pressure control, the method comprising:
positioning the variable volume mechanism of the system of claim 1 inline on a primary conduit;
attaching an end of a secondary conduit to the primary conduit upstream of the inlet end of the variable volume mechanism, wherein the upstream valve assembly is positioned inline of the secondary conduit, and wherein upstream is relative to a direction of fluid flow from the inlet end toward the outlet end of the variable volume mechanism; and
setting a low-pressure limit and a high-pressure limit on the control module, wherein the control module is configured to:
send electronic signals to a piston actuator to move the piston rod downward or upward to increase or decrease, respectively, a pressure in the primary conduit, and
send electronic signals to the upstream valve assembly to open the flow path through the upstream valve assembly so that fluid exits the pressure port and flows through the upstream valve assembly, and electronic signals to the piston actuator to move the piston rod downward or upward to increase or decrease, respectively, the pressure in the primary conduit.

14. The method of claim 13, wherein a process piping comprises a check valve positioned upstream of the inlet end of the flow path of the variable volume mechanism and downstream of the connection position of the secondary conduit to the process piping, and the control module is configured to:
send electronic signals to a piston actuator to move the piston rod downward to increase a pressure in the primary conduit downstream of the variable volume mechanism, or
send electronic signals to the piston actuator to move the piston rod down and electronic signals to the valve assembly to open the flow path through the upstream valve assembly so that fluid exits the pressure port and flows through the upstream valve assembly to increase the pressure in the primary conduit upstream of the check valve, or
send electronic signals to a piston actuator to move the piston rod upward to decrease a pressure in the primary conduit downstream of the variable volume mechanism, or
send electronic signals to the piston actuator to move the piston rod upward and send electronic signals to the upstream valve assembly to open the flow path through the upstream valve assembly so that fluid is pulled into the flow path through the upstream valve assembly and the pressure port to decrease the pressure in the primary conduit upstream of the check valve.

15. A method for pressure control, the method comprising:
positioning the variable volume mechanism of the system of claim 1 inline on a primary conduit;
attaching an end of a secondary conduit to the primary conduit upstream of the inlet end of the variable volume mechanism, wherein the upstream valve assembly is positioned inline of the secondary conduit, and wherein upstream is relative to a direction of fluid flow from the inlet end toward the outlet end of the variable volume mechanism; and
setting a low-pressure limit and a high-pressure limit on the control module, wherein the control module is configured to:
send electronic signals to a piston actuator to move the piston rod downward or upward to increase or decrease, respectively, a pressure in the primary conduit downstream of the variable volume mechanism,
send electronic signals to the upstream valve assembly to open the flow path therethrough so that fluid flows through the pressure port, and electronic signals to the piston actuator to move the piston rod downward or upward to increase or decrease, respectively, the pressure in the primary conduit, and
send electronic signals to the piston actuator to move the piston rod to the substantially fully retracted position and send electronic signals to the bypass valve assembly to open a fluid path through the bypass valve assembly so that fluid exits the bypass port and flows through the bypass valve assembly.
